(19) United States
(12) Patent Application Publication
(10) Pub. No.: US 2003/0201335 A1
(43) Pub. Date: Oct. 30, 2003

(54) Portable liquid recirculating display device that generates laminar liquid streams

(75) Inventors: Dave C. Brown, Chicago, IL (US); Richard E. Ellison, Chicago, IL (US); James W. Kendall, Mount Prospect, IL (US)

Correspondence Address: Timothy M. Kelly, Michael Best & Friedrich LLP, 100 East Wisconsin Avenue, Milwaukee, WI, 53202-4108, US

(73) Assignee: Haggerty Enterprises, Inc., Chicago, IL

(21) Appl. No.: 10/136,526

(22) Filed: Apr. 30, 2002

(51) Int. Cl. B05B 17/08

(52) U.S. Cl. 239/17

(57) ABSTRACT

A portable liquid recirculating display device including a housing with a cavity to contain a liquid, a pump to impel the liquid, and at least one laminar stream generator located within the cavity and fluidly connected to the pump.

### FIELD OF THE INVENTION

This invention relates generally to display devices for entertainment, and more particularly to liquid recirculating display devices.

### BACKGROUND OF THE INVENTION

Portable display fountains are commonly found in many households and places of business today. These fountains may vary in size, shape, and function, but the fundamental purposes of the fountains are entertainment and ornamental value.

The entertainment value of the fountain is usually enhanced if some sort of lighting effect is associated with the fountain. This is a common practice among those skilled in the art. Often, individual lights may be used either covered or uncovered by some transparent or translucent panels that diffuse light over their surface. The lights may also enhance the ornamental value of the fountain if they are contributing to the decorative features of the fountain.

Most often, portable display fountains are very simple in configuration. The fountain typically includes some kind of housing with a cavity for storing a supply of liquid. A pump is typically used to elevate a particular volume of liquid to some height, where it is allowed to fall back to the cavity under the influence of gravity. With this simple configuration, visual effects provided by the liquid are extremely limited.

### SUMMARY OF THE INVENTION

It is the general object of this invention to provide a portable display device, or fountain, that addresses the shortcomings of prior art. One embodiment of the present invention is a portable display fountain that includes a housing with a cavity where a supply of liquid is stored. A pump is used to pump the liquid to at least one laminar stream generator that is fluidly connected to the pump.

Another embodiment of the present invention is a portable display fountain that includes a housing with a cavity where a supply of liquid is stored. A pump is used to pump the liquid to at least one laminar stream generator that is fluidly connected to the pump. A controller is used to adjust at least one generator between allowing and preventing a laminar stream from exiting the housing of the portable display.

One embodiment of the laminar stream generator includes a canister having an inlet that receives liquid from the cavity of the housing and an outlet configured to discharge a laminar stream from the canister. A shutter moves between two positions on the laminar stream generator. In the first position, the shutter is positioned away from the outlet allowing a laminar stream to exit the housing of the portable display. The shutter is positioned over the outlet in the second position, preventing a laminar stream from exiting the housing of the portable display.

Further objects and advantages of the present invention, together with the organization and manner of operation thereof, will become apparent from the following detailed description of the invention when taken in conjunction with the accompanying drawings, wherein like elements have like numerals throughout the drawings.

### BRIEF DESCRIPTION OF THE DRAWINGS

The present invention is further described with reference to the accompanying drawings, which show preferred embodiments of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

FIG. 1 is a perspective view of a portable display fountain according to one embodiment of the present invention, illustrating laminar streams exiting a housing.

FIG. 2 is an exploded view of the fountain shown in FIG. 1.

FIG. 3 is a perspective view of the fountain shown in FIG. 1, illustrating the housing separated into a top portion and base portion.

FIG. 4 is a perspective view of a splitter of the fountain shown in FIG. 1

FIG. 5 is a cross-section view taken along line 5-5 in FIG. 4.

FIG. 6 is a perspective view of a laminar stream generator of the fountain shown in FIG. 1.

FIG. 7 is an exploded view of the laminar stream generator shown in FIG. 6.

FIG. 8 is a cross-section view taken along line 8-8 in FIG. 6.

FIG. 9 is an exploded view of a portable display fountain according to another embodiment of the present invention.

### DETAILED DESCRIPTION OF THE PREFERRED EMBODIMENT

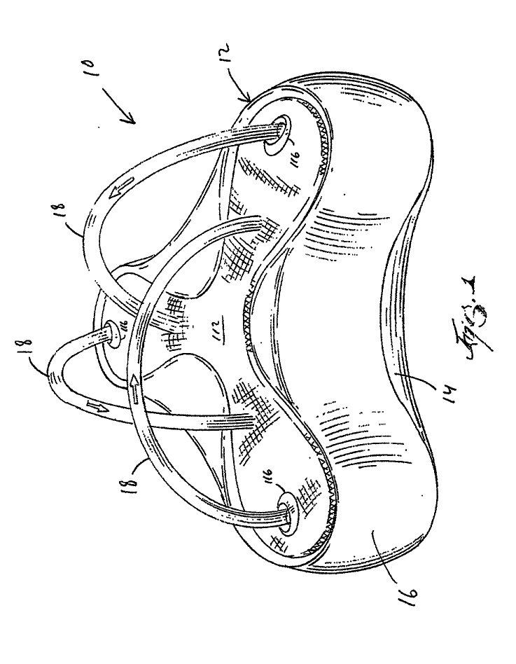

With reference to FIG. 1, one embodiment of the present invention is a portable liquid recirculating display device, or fountain 10. The fountain has a generally triangular shape and consists of a housing 12 separable into a base portion 14 and a top portion 16. Laminar streams 18 are shown exiting the housing 12 from each corner of the fountain 10. A supply of liquid (not shown) is maintained within the fountain 10 due to recirculation of the streams 18. To fully contain the fountain 10, a cover (not shown) may be mounted to the housing 12 to encapsulate the streams 18.

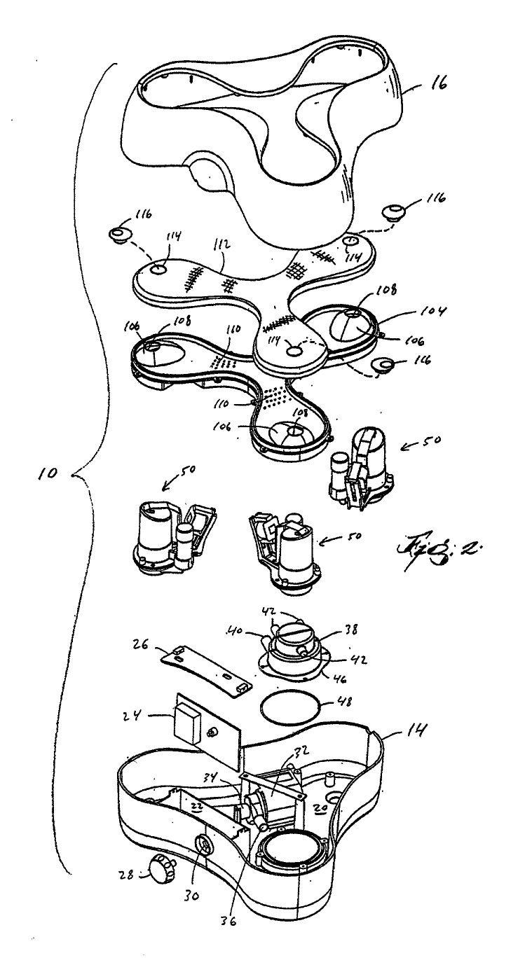

With reference to FIG. 2, an exploded view exposes the components of the fountain 10. The base portion 14 is molded having a first cavity 20 and a second cavity 22. The supply of liquid is maintained within the first cavity 20, and the second cavity 22 is sealed from the first cavity 20 such that any liquid or moisture from the first cavity 20 is prevented from entering the second cavity 22. A controller 24 with its associated wiring is mounted within the second cavity 22 and isolated from the first cavity 20 by a cover 26. A selector, or knob 28, connects to the controller 24 through an opening 30 in the base portion 14 to allow for selective adjustment of the controller 24. A serial port (not shown) is also connected to the controller 24. The serial port can also be any other type of input port operable to receive data.

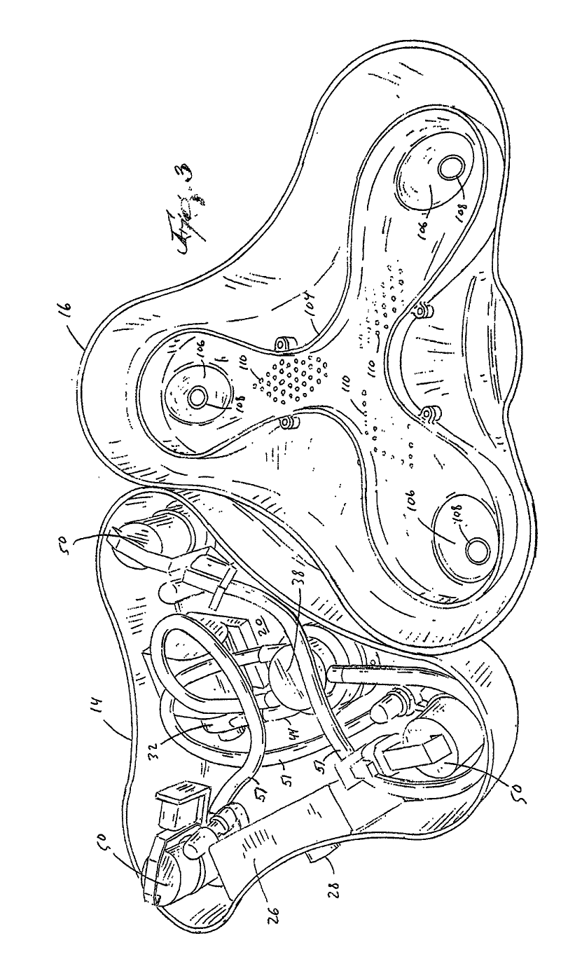

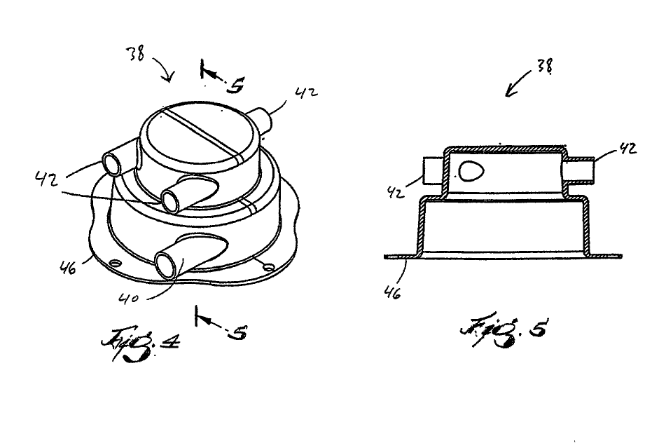

The cavity 20 houses a pump 32 sized to provide adequate pressure and flow for the fountain 10. The pump 32 has an intake port 34 that draws liquid from the cavity 20 and a discharge port 36 that impels the liquid at an increased pressure. A splitter 38 is mounted to the base portion 14 and has a singular inlet 40 and three outlets 42. The inlet 40 is fluidly connected to the discharge port 36 by a conduit 44 (FIG. 3), while a distinct flow is routed from each outlet 42. The splitter 38 is shown in further detail in FIGS. 4 and 5. The inlet 40 is shown towards the bottom of the splitter 38, or nearest a mounting flange 46 that is connected to the base portion 14. An oaring 48 is compressed between the mounting flange 46 and the base portion 14.

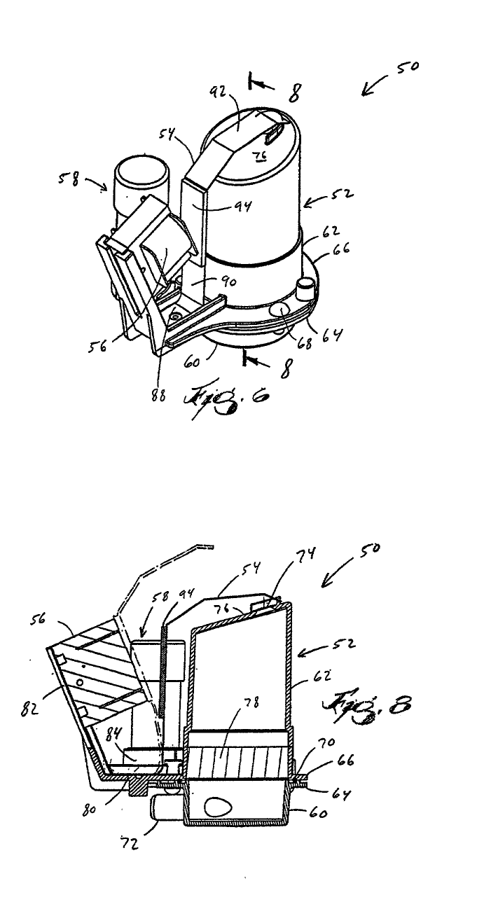

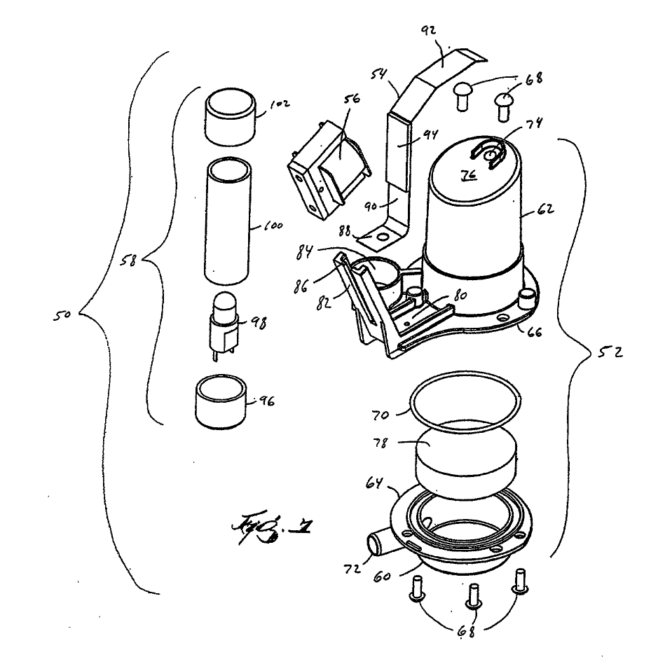

From the splitter 38, each of the distinct flows are routed to a respective laminar stream generator 50 through a conduit 51. With reference to FIGS. 6-8, the main components of the generator 50 include a canister 52, a shutter 54, an electromagnet 56, and a light 58. The canister 52 includes a bottom portion 60 and a top portion 62, whereby the two portions 60, 62 are coupled together at their respective flanges 64, 66 by ordinary fasteners 68. The canister 52 can also include any hollow body capable of containing a liquid that has a larger cross-sectional area than the cross-sectional area of the projected stream 18. For example, the canister 52 could include a tube, a hollow cylinder, a hollow sphere, or any other configuration used to accumulate the liquid prior to discharge as a laminar stream 18. An o-ring 70 is compressed between the flanges 64, 66 to seal the canister 52. The same fasteners 68 used to couple the portions 60, 62 are also used to mount the generator 50 to the base portion 14. The bottom portion 60 includes an inlet 72 that is fluidly coupled to one of the splitter outlets 42 by the conduit 51. The top portion 62 includes an outlet 74 where a laminar stream 18 is projected. The top portion 62 has an angled top surface 76, whereby the outlet 74 is positioned near the highest point of the top surface 76. A foam diffuser 78 is positioned within the canister 52 and between the inlet 72 and outlet 74.

The top portion 62 also includes a shutter flange 80, an electromagnet flange 82, and a light socket holder 84. The shutter flange 80 is integrally molded with the top portion 62 and extends from the top portion 62 in a direction parallel to the flange 66. The electromagnet flange 82 extends from the shutter flange 80 at an angle relative to the shutter flange 80. A slot 86 is molded on the flange 82 to slidably accept the electromagnet 56. The light socket holder 84 is also integrally molded with the top portion 62, extends in a direction parallel to the flange 66, and is located adjacent to the shutter flange 80.

The shutter 54 is a thin, substantially rigid, yet flexible metal strip that includes a lower portion 88, an intermediate portion 90, and an upper portion 92. Both portions 88, 92 are substantially horizontal, while the intermediate portion 90 substantially vertically connects the two portions 88, 92. The lower portion 88 is coupled to the shutter flange 80, while the intermediate portion 90 extends vertically with the canister 52. A metal plate 94 is coupled to the intermediate portion 90 and is also in a facing relationship with the electromagnet 56. The upper portion 92 extends over the canister 52 and is biased to cover the outlet 74. No discernable pivot point is seen on the shutter 54.

The electromagnet 56 is a commonly available component and is slidably mounted on the flange 82. Ordinary fasteners (not shown) are used to secure the electromagnet 56 within the slot 86 once it is positioned. The electromagnet 56 is electrically connected with the controller 24.

The light 58 is mounted in the light socket holder 84 and comprises a socket 96, a bulb 98, a cover 100, and a cap 102. The socket 96 is electrically connected with the controller 24, while the bulb 98 electrically engages the socket 96, making the bulb 98 electrically connected with the controller 24. The cover 100 and cap 102 can be colored such that the light 58 emits a colored hue.

Referring back to FIGS. 2 and 3, a false ceiling 104 is positioned above the cavity 20 and mounted to the top portion 16. The ceiling 104 is translucent, so that light is allowed to pass through the ceiling 104, while hiding the internal components from view. The ceiling 104 is molded to include multiple raised surfaces 106, each surface 106 located above a generator 50. Each raised surface 106 includes a hole 108 through which a laminar stream 18 is projected. The ceiling 104 is also molded to include a series of drainage holes 110.

A screen 112 is positioned above the ceiling 104 and mounted to the top portion 16. The screen 112 is formed to closely approximate the shape of the ceiling 104. Like the ceiling 104, the screen 112 has holes 114 that are coaxial with the holes 108 of the ceiling 104. Spouts 116 are mounted around each hole 114 to maintain the shape of the hole 114 in the screen 112 and for decorative purposes. The screen 112 is manufactured of a corrosion-resistant, wire mesh material. The wire mesh and wire diameters are sized appropriately to avoid splashing and spilling of the liquid outside the boundary of the fountain 10. The wire mesh is large enough to allow the streams 18 to pass through without forming a meniscus, but small enough to maintain any splashing within the housing 12. The wire diameters must be small enough to prevent the streams 18 from splashing off the individual wires, but large enough to maintain the structural rigidity of the screen 112. The screen 112 includes a mesh density of 11 openings per linear inch with individual wire diameters of 0.015 inches. Alternatively, the advantages of the present invention are effectively accomplished when the mesh density is between 9 and 13 openings per linear inch and the wire diameter is between 0.013 and 0.018 inches. Mesh density is measured in “openings per linear inch,” which is an industry standard of measurement. An “opening” is defined as the area between two adjacent, parallel wires.

Referencing back to FIG. 1, laminar streams 18 are shown projecting from one location on the fountain 10 to a different location on the fountain 10. Each laminar stream 18 has a trajectory such that the stream 18 lands near an adjacent corner of the fountain 10 from which it originates. The laminar streams 18 are produced by a combination of the elements previously described.

The pump 32 draws liquid from the cavity 20 through the intake port 34 and pressurizes it for release through the discharge port 36. The inlet 40 of the splitter 38 is fluidly connected with the discharge port 36 through the conduit 44 such that the interior of the splitter 38 fills with the pressurized liquid. From the interior, the liquid exits the splitter 38 through three outlets 42. Each outlet diameter is the same, allowing the liquid to exit the splitter 38 at substantially the same flow rate for each outlet 42.

Each outlet 42 is fluidly connected to a laminar stream generator 50 (FIG. 3) by a conduit 51. The liquid enters each generator 50 through an inlet 72, where it must pass through a foam diffuser 78 before exiting through the outlet 74. The diffuser 78 acts to decrease any turbulence in the incoming flow. The diffuser 78 can also help mask any variations in the flow caused by variations in pump operation.

As shown in FIG. 8, the shutter 54 is movable between two distinct positions. The shutter 54 is biased towards a blocking position whereby the shutter is positioned over the outlet 74 to deflect the laminar stream 18. It should be known that a laminar stream 18 is continuously projecting from each canister 52 while the fountain 10 is in operation. In the blocking position, the shutter 54 deflects the stream 18 back into the cavity 20, thus preventing the stream 18 from projecting beyond the ceiling 104. When the controller 24 activates the electromagnet 56, the metal plate 94 is attracted to the electromagnet 56, thus causing the shutter 54 to move towards a non-blocking position (shown by phantom lines in FIG. 8). The shutter 54 moves towards a non-blocking position by bending about the intermediate portion 90. In the non-blocking position, the outlet 74 is uncovered so that a laminar stream 18 is allowed to project beyond the ceiling 104. The inherent stiffness of the shutter 54 maintains its bias towards the blocking position, but the electromagnetic force exerted on the shutter 54 by the electromagnet 56 is enough to overcome this bias and bend the shutter towards the non-blocking position.

Upon return to the fountain 10, the streams 18 must pass through the screen 112 before impacting the ceiling 104. The screen 112 helps to disperse the stream 18 into a larger area before impact with the ceiling 104. This helps decrease the amount of splashing that occurs at the ceiling 104 upon impact of the streams 18. The screen 112 also maintains the splashing caused by impact within the housing 12.

The purpose of the ceiling 104 is primarily to hide from view the internal components of the fountain 10. Also, the ceiling 104 contributes a decorative aspect to the fountain 10 as each light 58 illuminates a section of the ceiling 104 while illuminating the streams 18 as they project from the generators 50. Drainage holes 110 allow the liquid collecting on the ceiling 104 to drain back into the cavity 20 for recirculation.

The controller 24 activates the generators 50 and the lights 58 through a series of programmed sequences adjustable by the knob 28. A program included in the controller 24 contains information governing these programmed sequences. The serial port (not shown) is capable of receiving data from some source, whereby the data contains information to add a program, modify an existing program, or replace an existing program. The source of the data can include a plug-in module (not shown) that is independent of any other computing device, or can include an internet download through a computer (not shown) and transmitted through a cable (not shown) to the serial port.

The controller 24 may activate and deactivate the generator 50 in such a way so that laminar stream projectiles (not shown) are created rather than a laminar stream 18 as shown in FIG. 1. Laminar stream projectiles are broken-out sections of a laminar stream 18. An example sequence governed by the controller 24 includes a laminar projectile appearing to “jump” between adjacent corners of the fountain 10 in a clockwise or counter-clockwise direction. When a generator 50 releases a projectile towards an adjacent corner of the fountain 10, the light 58 associated with that generator 50 illuminates or flashes. This sequence repeats in either a clockwise or counter-clockwise direction around the fountain 10. Alternatively, another example sequence includes each generator 50 simultaneously releasing a projectile towards an adjacent corner of the fountain 10 whereby a projectile lands in each corner of the fountain 10. Similarly, other programmed sequences which coordinate activation of the generators 50 and the lights 58 are within the scope of the present invention.

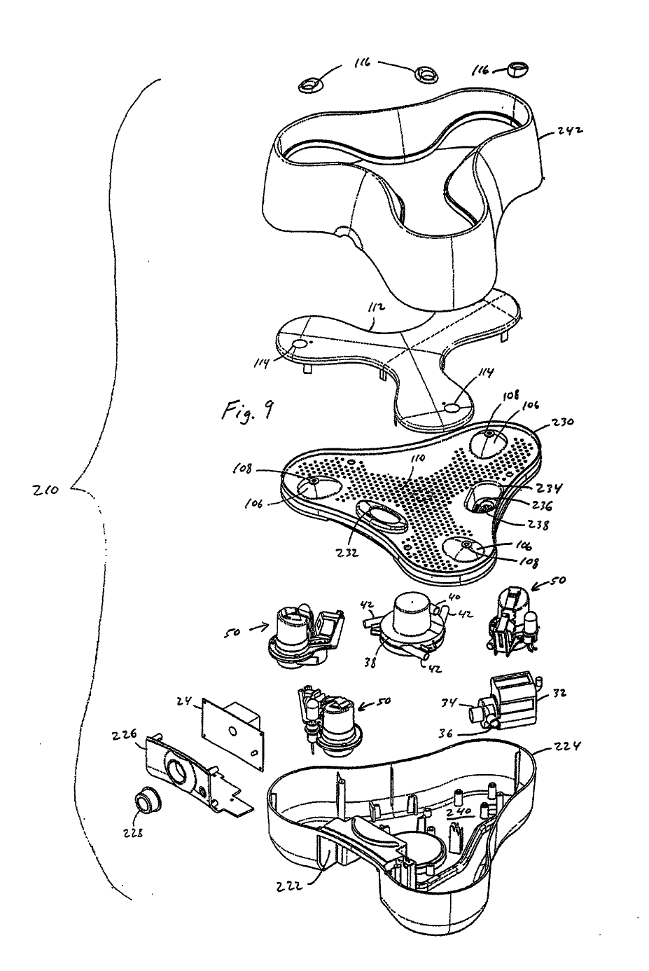

With reference to FIG. 9, another embodiment of the fountain 10 is shown in an exploded view. The fountain 210 functions in a similar manner as the fountain 10, however the fountain 210 differs structurally from the fountain 10 in some respects. For example, rather than being accessible from the top of the base portion 14 (FIG. 2), a second cavity 222 is accessible from the side of a base portion 224. A cover 226 is positioned over the cavity 222 to prevent access to the controller 24 within the cavity 222. A button 228 connects to the controller 24 through the cover 226 to selectively adjust the controller 24 and the operation of the fountain 210.

Also, a false ceiling 230 is molded to include a fill slot 232 and a fill level indicator 234. The fill level indicator 234 is molded as a recessed portion 236 in the ceiling 230 with apertures 238 through the bottom of the recessed portion 236. The ceiling 230 is coupled to the base portion 224 rather than the top portion 16 of the fountain 10. This is done to prevent access to internal components while allowing the cavity 240 to be filled.

The cavity 240 is filled with liquid by first removing a top portion 242 to expose the ceiling 230, then pouring the liquid through the fill slot 232. The cavity 240 is considered full when the liquid ascends through the apertures 238 and into the recessed portion 236 of the fill level indicator 234. The fill level indicator 234 also changes color when the appropriate fill level has been reached.

We claim:

1. A portable liquid recirculating display device comprising:
a housing having a cavity adapted to contain a liquid;
a pump adapted to impel the liquid; and
at least one laminar stream generator fluidly connected to the pump.

2. The portable liquid recirculating display device of claim 1, wherein the at least one generator is positioned within the cavity.

3. The portable liquid recirculating display device of claim 1, wherein the at least one generator is adapted to discharge a laminar stream of liquid from inside of the housing to outside of the housing.

4. The portable liquid recirculating display device of claim 3, further comprising a cover coupled to the housing and adapted to encapsulate the laminar stream of liquid.

5. The portable liquid recirculating display device of claim 3, wherein the laminar stream returns from outside of the housing to the cavity.

6. The portable liquid recirculating display device of claim 5, wherein the housing includes a false ceiling positioned above the cavity, the false ceiling having at least one spout positioned above the at least one generator and adapted to allow passage of the laminar stream through the false ceiling.

7. The portable liquid recirculating display device of claim 6, wherein the false ceiling is translucent.

8. The portable liquid recirculating display device of claim 6, wherein the false ceiling includes drainage holes adapted to allow the liquid of the laminar stream to return to the cavity through the false ceiling.

9. The portable liquid recirculating display device of claim 6, wherein the false ceiling includes a recessed portion having apertures there through, the recessed portion indicating a fill level of the liquid.

10. The portable liquid recirculating display device of claim 5, wherein the housing includes a screen positioned above the cavity and adapted to allow passage of the laminar stream there through without splashing.

11. The portable liquid recirculating display device of claim 10, wherein the screen includes a wire mesh having a mesh density approximately between 9 and 13 openings per linear inch.

12. The portable liquid recirculating display device of claim 11, wherein the mesh density is approximately 11 openings per linear inch.

13. The portable liquid recirculating display device of claim 10, wherein the screen includes a wire mesh having wires, the wires each having a diameter approximately between 0.013 and 0.018 inches.

14. The portable liquid recirculating display device of claim 13, wherein each diameter is approximately 0.015 inches.

15. The portable liquid recirculating display device of claim 10, wherein the screen is a stainless steel screen.

16. The portable liquid recirculating display device of claim 5, wherein the pump is positioned within the cavity.

17. The portable liquid recirculating display device of claim 5, wherein the pump includes an intake port and a discharge port, the intake port adapted to draw liquid from the cavity and the discharge port adapted to impel liquid to the at least one laminar stream generator.

18. The portable liquid recirculating display device of claim 17, further comprising a splitter positioned within the cavity, the splitter including an inlet fluidly connected to the discharge port, and at least one outlet fluidly connected to the at least one generator.

19. A portable liquid recirculating display device comprising:
a housing having a cavity adapted to contain a liquid;
a pump adapted to move the liquid;
a plurality of laminar stream generators fluidly connected to the pump; and
a controller operably connected to each of the plurality of generators to adjust each of the plurality of generators between a first position allowing a laminar stream to exit the housing and a second position preventing the laminar stream from exiting the housing.

20. The portable liquid recirculating display device of claim 19, wherein the generators are positioned within the cavity.

21. The portable liquid recirculating display device of claim 19, wherein the controller includes at least one program that adjusts each of the plurality of generators according to a programmed sequence.

22. The portable liquid recirculating display device of claim 21, wherein the controller includes a connection port coupled to the controller and adapted to receive data.

23. The portable liquid recirculating display device of claim 22, wherein the data contains information sufficient to cause a change in the at least one program included in the controller.

24. The portable liquid recirculating display device of claim 19, wherein the housing includes an additional cavity, and wherein the controller is positioned in the additional cavity.

25. The portable liquid recirculating display device of claim 24, wherein the additional cavity is fluidly sealed from the cavity.

26. The portable liquid recirculating display device of claim 19, further comprising a plurality of lights, the controller electrically connected to the plurality of lights to activate the lights in a programmed sequence.

27. The portable liquid recirculating display device of claim 26, wherein the plurality of lights includes first, second, and third lights, and the plurality of generators includes first, second, and third generators, the first, second, and third light being coupled to the first, second, and third generator, respectively.

28. The portable liquid recirculating display device of claim 26, further comprising a user-selectable switch operably coupled to the controller, the switch adjustable to vary the adjustment of each of the plurality of generators and the programmed sequence of the plurality of lights.

29. The portable liquid recirculating display device of claim 28, wherein the user-selectable switch is a knob.

30. The portable liquid recirculating display device of claim 28, wherein the user-selectable switch is a button.

31. The portable liquid recirculating display device of claim 19, wherein the first position initiates a laminar projectile exiting the housing and the second position terminates the laminar projectile.

32. A laminar stream generator for a portable liquid recirculating display device including a housing adapted to contain a liquid, the generator comprising:
a canister including a cavity having an inlet adapted to receive the liquid from the housing and an outlet adapted to discharge a laminar stream of the liquid from the canister; and
a shutter movable between a first position where the shutter is positioned away from the outlet adapted to allow the laminar stream to exit the canister, and a second position where the shutter is positioned over the outlet and adapted to prevent a laminar stream from exiting the housing.

33. The laminar stream generator of claim 32, wherein the shutter is made of a flexible material to allow bending between the first and second positions.

34. The laminar stream generator of claim 32, wherein the shutter is coupled to the canister.

35. The laminar stream generator of claim 32, wherein the canister is adapted to continuously move liquid through the inlet and outlet of the canister.

36. The laminar stream generator of claim 35, further comprising a foam diffuser positioned within the cavity and between the inlet and outlet of the canister.

37. The laminar stream generator of claim 35, wherein the canister includes an angled top surface, the outlet positioned near the highest part on the top surface.

38. The laminar stream generator of claim 35, further comprising an electromagnet adjustable between an active state that moves the shutter to the first position and an inactive state that allows the shutter to move to the second position.

39. The laminar stream generator of claim 38, wherein the shutter is biased toward the second position.

40. The laminar stream generator of claim 39, wherein the shutter includes a metal plate coupled to the shutter and in a facing relationship with the electromagnet.

41. The laminar stream generator of claim 40, wherein the metal plate is attracted to the electromagnet when the electromagnet is in the active state, and wherein the electromagnet allows the metal plate to move away from the electromagnet under the bias of the shutter when the electromagnet is in the inactive state.
